(19) United States
(12) Patent Application Publication
(10) Pub. No.: US 2012/0202516 A1
(43) Pub. Date: Aug. 9, 2012

(54) APPARATUS AND METHOD FOR PROVIDING LOCATION-BASED DATA

(75) Inventors: Yu-Ri AHN, Seoul (KR); Nam-Joong KIM, Seoul (KR); Eun-Jeong KIM, Seoul (KR); Tae-Ho KIM, Seongnam-si (KR); Hyun-Su KIM, Seoul (KR); Kwang-Seok SEO, Seoul (KR); Hyun-Sup YOON, Seoul (KR)

(73) Assignee: PANTECH CO., LTD., Seoul (KR)

(21) Appl. No.: 13/195,477

(22) Filed: Aug. 1, 2011

(30) Foreign Application Priority Data
Feb. 8, 2011 (KR) 10-2011-0011134

(51) Int. Cl. H04W 64/00

(52) U.S. Cl. 455/456.1

(57) ABSTRACT

An apparatus capable of providing location-based data includes a communication unit to transmit data to a server and to receive base location-based data from the server via a communication network, a display unit to display the base location-based data, and a control unit to control the display unit to further display synthesized data including first user location-based data and the base location-based data. A method for providing location-based data includes acquiring user location-based data including location information, acquiring base location-based data including location information, and synthesizing the user location-based data into corresponding region of the base location-based data.

### CROSS-REFERENCE TO RELATED APPLICATION(S)

This application claims priority from and the benefit under 35 U.S.C. §119(a) of Korean Patent Application No. 10-2011-0011134, filed on Feb. 8, 2011, which is incorporated by reference for all purposes as if fully set forth herein.

### BACKGROUND

1. Field

The following description relates to a communication system, and particularly, to an apparatus and method for providing location-based data.

2. Discussion of the Background

Location-based data provided by communication systems is largely classified into digital maps and road views. Digital maps such as Google Map show locations of moving objects (such as vehicles) in real-time and provide information corresponding to the locations of the moving objects. Road views are static images including photographs of buildings, roads and streets obtained from various locations.

Currently available digital maps simply display locations of places or buildings in a certain area, and do not provide detailed map information corresponding to each of the places or buildings. Thus, users of location-based data may not be able to look up their detailed location information on digital maps or road views when they enter certain places or buildings. For example, digital maps simply show the location of Gyeongbok Palace in Seoul and do not provide detailed guide information corresponding to detailed inner structures of Gyeongbok Palace. Thus, users need to look up guide maps and to find their current location on the guide maps for Gyeongbok Palace to obtain more detailed information of Gyeongbok Palace.

Further, since availability of road views is limited to certain places or specific directions, users of road view service may not be able to obtain road views of places of interest.

### SUMMARY

Exemplary embodiments of the present invention provide a method for providing location-based data, including acquiring user location-based data including location information; acquiring base location-based data; and synthesizing the user location-based data into a corresponding region of the base location-based data. Exemplary embodiments of the present invention also provide an apparatus to provide location-based data.

Additional features of the invention will be set forth in the description which follows, and in part will be apparent from the description, or may be learned by practice of the invention.

Exemplary embodiments of the present invention provide a method for providing location-based data, including receiving a request for location-based data including location information; determining whether the location information belongs to a user database region for which user location-based data is available; extracting synthesized data including the user location-based data and a base location-based data if the location information belongs to the user database region; and providing the synthesized data.

Exemplary embodiments of the present invention provide an apparatus to provide location-based data, including a communication unit to transmit data to a server and to receive base location-based data from the server via a communication network; a display unit to display the base location-based data; and a control unit to control the display unit to display synthesized data including first user location-based data and the base location-based data.

Exemplary embodiments of the present invention provide a server apparatus to provide location-based data, including a communication unit to transmit and receive data to and from a terminal via a communication network; a base database to store base location-based data provided by a service provider; a control unit to synthesize a user location-based data and the base location-based data into synthesized data; and a database to store the synthesized data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an apparatus to provide location-based data according to an exemplary embodiment of the present invention.

FIG. 2 is a flowchart illustrating a method for providing location-based data according to an exemplary embodiment of the invention.

FIG. 3A is a diagram illustrating a base map according to an exemplary embodiment of the invention.

FIG. 3B is a diagram illustrating a user map according to an exemplary embodiment of the invention.

FIG. 4A, FIG. 4B, and FIG. 4C are diagrams illustrating synthesizing a user map and a base map according to an exemplary embodiment of the invention.

FIG. 5A and FIG. 5B are flowcharts illustrating a method for providing location-based data according to an exemplary embodiment of the invention.

FIG. 6 is a diagram illustrating synthesizing a user road view and a base road view according to an exemplary embodiment of the invention.

FIG. 7 is a diagram illustrating a provision of a road view to a terminal according to an exemplary embodiment of the invention.

FIG. 8 is a diagram illustrating a map showing regions where user road views are available and regions where base road views are available according to an exemplary embodiment of the invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which embodiments of the invention are shown. The present disclosure may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

It will be understood that when an element is referred to as being “connected to” another element, it can be directly connected to the other element, or intervening elements may be present. Also, descriptions of well-known functions and constructions may be omitted for increased clarity and conciseness.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

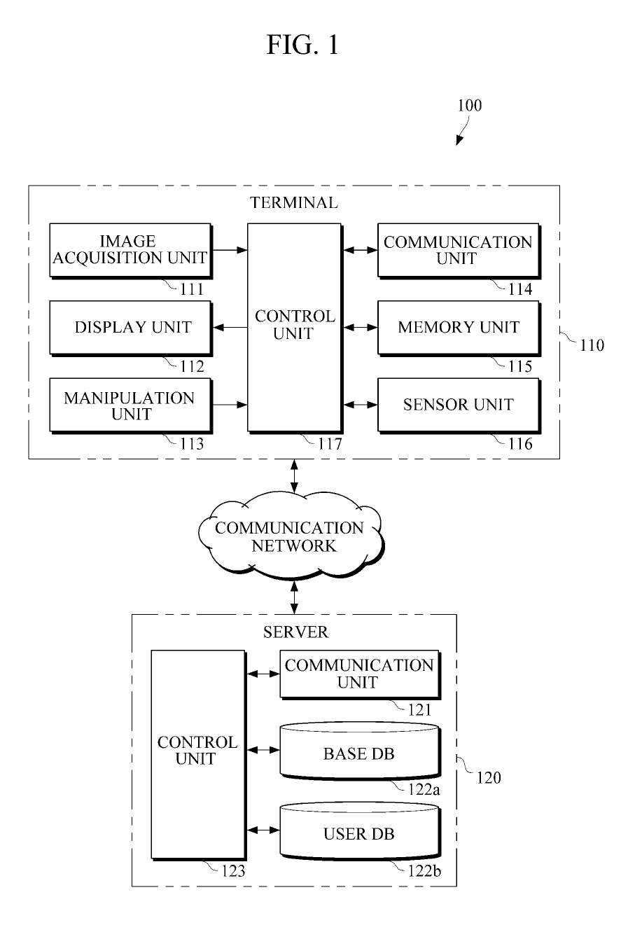

FIG. 1 is a diagram illustrating an apparatus to provide location-based data according to an exemplary embodiment of the present invention.

As shown in FIG. 1, the apparatus 100 includes a terminal 110 and a server 120 to provide location-based data to the terminal 110, and the terminal 110 and the server 120 are connected to each other via a communication network. The communication network may be wired and/or wireless communication network.

The terminal 110 may be a mobile communication terminal, such as a mobile phone, a smart phone, a personal digital assistant (PDA), a navigation device, or a personal computer including a desktop computer, a laptop computer and a tablet computer. The terminal 110 may be any type of device capable of receiving location-based data provided by a service provider from the server 120 and synthesizing the received location-based data and location-based data acquired by a user.

The terminal 110 includes an image acquisition unit 111, a display unit 112, a manipulation unit 113, a communication unit 114, a memory 115, a sensor unit 116, and a control unit 117.

The image acquisition unit 111 acquires an image, and outputs the acquired image to the control unit 117. The image acquisition unit 111 processes image frames such as still or moving images of the real world acquired by an image sensor. The image acquisition unit 111 may be a camera capable of enlarging or reducing image size under the control of the control unit 117 or capable of being rotated either automatically or manually. The image acquisition unit 111 may acquire user location-based data. Location-based data is information data relating to location information such as digital maps, and road views. Base location-based data is location-based data including base map and base road views, which may be provided by service providers. An example of a base map is ‘Google Maps’ and an example of a base road view is Google's ‘Street View’. The user location-based data is location-based data of a specific region or an area which may be created or acquired by an anonymous user. In an example, the user location-based data may include a captured image of a detailed map of a particular location (“user map”) or a captured road view of a particular location (“user road view”). The user location-based data may be acquired by capturing images using the terminal 110 or may be downloaded from other sources.

The display unit 112 outputs an image inputted from an external source or an image stored in the terminal 110. The display unit 112 may be a display panel such as a liquid crystal display (LCD), and a light-emitting diode (LED) capable of displaying images or text thereon. The display unit 112 may be embedded in the terminal 110 or may be connected to the terminal 110 from the exterior of the terminal 110 via an interface unit, such as a universal serial bus (USB) port. The display unit 112 may display information processed by the terminal 110 as well as a user interface (UI) or a graphic user interface (GUI) relevant to a control operation. In an example, the display unit 112 may be configured to form a mutual layer structure with a sensor capable of sensing a touch input (hereinafter referred to as a “touch sensor”), the display unit 112 may also be used as a manipulation unit 113.

The manipulation unit 113, which is a user interface unit, may receive various types of information from a user. In an example, the manipulation unit 113 may receive a request for displaying synthesized data from a user of the terminal 110. The manipulation unit 113 may include a key input unit, which generates key information whenever each key button is pressed, a touch sensor, voice sensor, and a mouse.

The communication unit 114 processes signals received from an external source via the communication network and outputs the processed signals to the control unit 117. The communication unit 114 also processes signals under the control of the control unit 117 and transmits the processed signals to the outside of the terminal 110 via the communication network. The memory unit 115 may store user map images acquired by the image acquisition unit 111 as user location-based data.

The sensor unit 116 determines the current location of the terminal 110, the image capturing direction of the terminal 110, a variation in the position of the terminal 110, a variation in the image capturing speed of the terminal 110, a variation of the moving speed of the terminal 110, a variation of the capturing direction of the terminal 110, and/or the time information of sensing information, and outputs determination results of the sensing information to the control unit 117. In an example, the sensor unit 116 may include a global positioning system (GPS) receiver which receives location information of the terminal 110 from a GPS satellite, a gyro-sensor which senses the azimuth, the azimuth angle, and the inclination angle of the terminal 110, and an acceleration sensor which senses the direction and acceleration of the rotation and rotation angle of the terminal 110, and generate a sensing signal based on the results of the sensing.

The control unit 117 controls the image acquisition unit 111, the display unit 112, the manipulation unit 113, the communication unit 114, the memory unit 115, and the sensor unit 116 of the terminal 110 and may be a hardware processor, or a software module that can be executed in a hardware processor. The operation of the control unit 117 will be described later in further detail. Further, the functions performed by the units described above for the terminal 110 are not limited as such, and may be performed in full or in part by one or more other units, including those described above, of the terminal 110. For example, certain computational-based functions of image acquisition unit 111, display unit 112, manipulation unit 113, communication unit 114, memory unit 115, and/or sensor unit 116 may be performed by the control unit 117.

The server 120 includes a communication unit 121, a base database (“base DB”) 122a, a user database (“user DB”) 122b, and a control unit 123.

The communication unit 121 processes signals received from an external source via a communication network and outputs the processed signals to the control unit 123. The communication unit 121 also processes signals under the control of the control unit 123 and transmits the processed output signals to the outside of the server 120 via the communication network. The base DB 122a and the user DB 122b both store location-based data. The base DB 122a may store map data or road view data provided by one or more service providers. The user DB 122b may store location-based data acquired by a user.

The control unit 123 controls the communication unit 121, the base DB 122a, and the user DB 122b of the server 120, and controls processing and provision of location-based data. The control unit 123 may be a hardware processor, or a software module that can be executed in a hardware processor. The operation of the control unit 123 will be described later in further detail. Further, the functions performed by the units described above for the server 120 are not limited as such, and may be performed in full or in part by one or more other units, including those described above, of the server 120. For example, certain computational-based functions of communication unit 121, the base DB 122a, and/or the user DB 122b may be performed by the control unit 123.

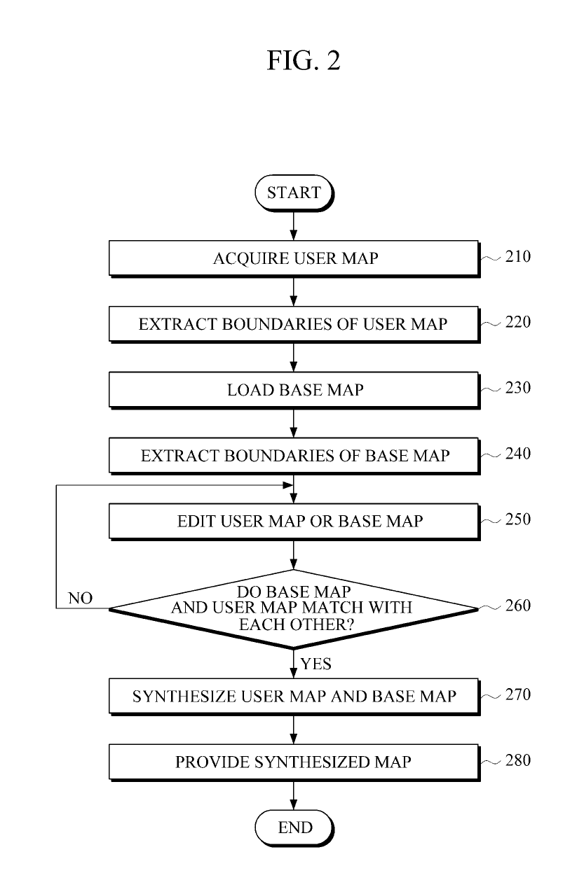

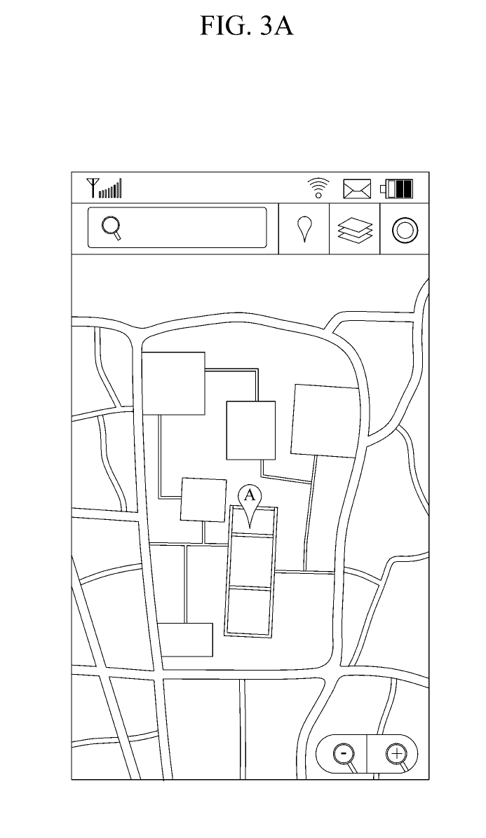

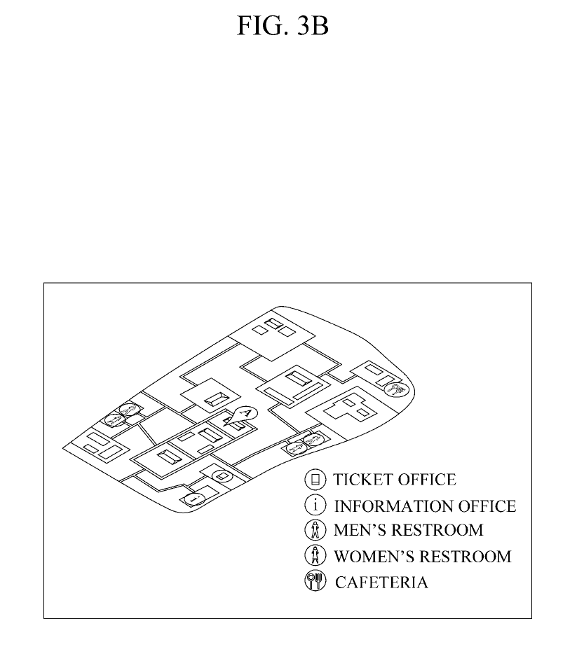

FIG. 2 is a flowchart illustrating a method for providing location-based data according to an exemplary embodiment of the invention. For ease of description, FIG. 2 will be described as if the method is performed by the terminal 110. However, the method is not limited as such. FIG. 3A is a diagram illustrating a base map according to an exemplary embodiment of the invention. FIG. 3B is a diagram illustrating a user map according to an exemplary embodiment of the invention.

Referring to FIG. 2, the control unit 117 of the terminal 110 acquires a user map (210). Examples of the user map may be an image captured by the user of the terminal 110 and an image provided by another user. An example of the acquired user map, i.e., a guidebook or guide map for Gyeongbok Palace, is illustrated in FIG. 3B.

The control unit 117 extracts the boundaries of the acquired user map in response to a user map synthesis request received from a user (220). The user map synthesis request is a request command for synthesizing a user map into a base map inputted by a user through the manipulation unit 113. For example, functions for extracting the boundaries of an image, including ‘crop’ and ‘select’ functions may be provided, and thus, only relevant parts of the acquired user map may be selected using the extracting functions. Further, relevant information included in the acquired user map may also be selected using the extracting functions.

The control unit 117 loads a base map of which location is corresponding to the location in the acquired user map (230). The base map may be loaded from the memory unit 115 or may be received through communication unit 114. An example of the acquired base map is illustrated in FIG. 3A. In an example, the control unit 117 may acquire current location information of the terminal 110 from the sensor unit 116, and may load a map corresponding to the acquired location information from the server 120. Alternatively, the control unit 117 may load a base map corresponding to an input keyword inputted from the user via the manipulation unit 113, or the control unit 117 may extract one or more base maps of places located within a reference range from the current location of the terminal 110. The extracted maps have similar boundaries to the acquired user map, and may allow the user to select one of the maps.

Further, the control unit 117 may sort the extracted maps from the most similar one to the least similar one based on a similarity comparison result. In an example, the similarity comparison result may be generated by the control unit 117. The control unit 117 extracts main boundaries of the acquired user map and main boundaries of base maps within the reference range. The main boundaries may be external boundaries that determine the outline of the place. Next, the control unit 117 compares the main boundaries of the acquired user map with the main boundaries of base maps within the reference range. Then, the control unit 117 sorts the base maps based on the similarity of the main boundaries and selects a certain number of base maps for candidates. Next, the control unit 117 extracts detailed boundaries of the acquired user map and detailed boundaries of the candidates. The extraction of the detailed boundaries of the sorted base maps may be performed from the base map which has the most similar main boundaries compared to the main boundaries of the acquired user map. Next, the control unit 117 compares the detailed boundaries of the acquired user map with the detailed boundaries of the candidates and generates a similarity comparison result.

The control unit 117 extracts the boundaries of the acquired base map (240). The control unit 117 provides guidelines enabling the user to edit the user map or the base map via the display unit 112 (250). The guidelines may be an overlaid view of the extracted user map boundaries and the extracted base map boundaries, and may be provided to allow the user to properly synthesize a user map and a base map. In an example, guidelines are indicated both on the base map and the user map so that the user may edit the user map or the base map to match the user map with the base map with reference to the guidelines. Further, the extracted user map boundaries may be indicated by one color and the corresponding boundaries of the extracted base map boundaries may be indicated by another color. If the extracted user map boundaries and the corresponding boundaries of the extracted base map boundaries are matched with each other the colors may be changed into a specific color that indicates proper matching. In an example, the extracted user map boundaries and the corresponding boundaries of the extracted base map boundaries may be indicated by blue and green, respectively. If the extracted user map boundaries and the corresponding boundaries of the extracted base map boundaries are matched with each other the colors may be changed into purple.

The overlaid view may be controlled by changing opacities of the user map and the base map. In an example, opacity of the user map and the base map can be scaled from 0 to 1. ‘0’ indicates completely transparent and ‘1’ indicates completely opaque. Thus, the user may control the opacities of the user map and the base map to modify the synthesized map for better visibility.

In an example, if a user map is interior structural map of a building, the synthesized map may have a mark on the building indicating availability of the interior structural map of the building. If the user clicks the building on the synthesized map, the interior map may be displayed on the display unit 112. If the user clicks the displayed interior map, different floor map can be displayed.

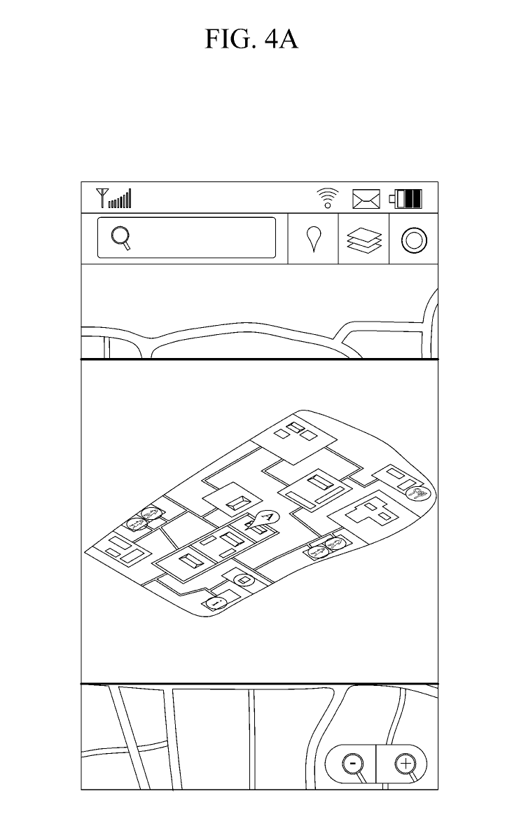

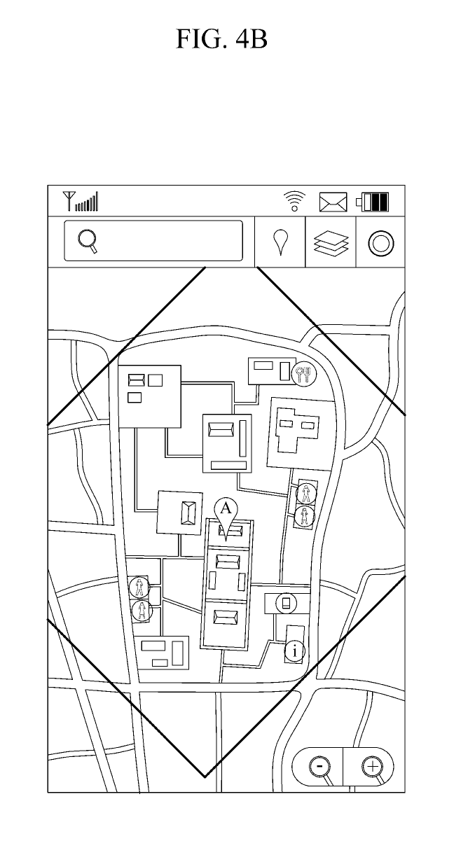

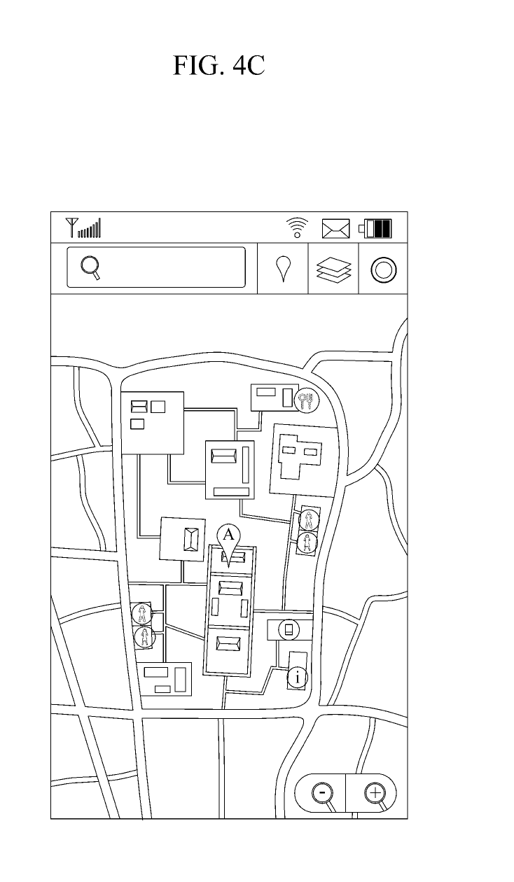

In an example, guidelines of the user map are indicated by bold lines. An example of the guidelines is illustrated in FIG. 4A and FIG. 4B. The acquired user map and the acquired base map may not be matched with each other in terms of size, direction, and location, thus the control unit 117 may edit the size, direction, and location of the acquired user map so that the acquired user map can be matched with the acquired base map, as illustrated in FIG. 4B. Alternatively, the control unit 117 may edit the size, direction, and location of both the acquired user map and the acquired base map. The editing of the acquired user map by the control unit 117 may be performed either automatically or manually in response to a user input. An example of the editing of the acquired user map is illustrated in FIG. 4B. As shown in FIG. 4A and FIG. 4B, the acquired user map may be rotated so as to be matched with the acquired base map. The automatic editing can be performed by the control unit 117 using information of the extracted boundaries of the acquired user map and of the acquired base map.

The control unit 117 determines whether the edited user map and the acquired base map match (260). For example, the control unit 117 may determine matching ratio between the edited user map and the acquired base map and compare the matching ratio with a threshold value.

If the matching ratio is higher than the threshold value, the control unit 117 synthesizes the edited user map and the acquired base map (270). An example of a synthesized map obtained by synthesizing the edited user map and the acquired base map is illustrated in FIG. 4C. The control unit 117 may provide a map obtained by replacing a part of the acquired base map inside the extracted base map boundaries with the edited user map to the user as the synthesized map (280), as illustrated in FIG. 4C. The control unit 117 marks the current location of the terminal 110 identified by the sensor unit 116 on the synthesized map obtained in operation 270. Thus, if the user is located in the area in the synthesized map obtained in operation 270, the location of the user may be marked on the synthesized map obtained in operation 270, thereby providing the user with his or her relative location information.

If the matching ratio is not higher than the threshold value in operation 260, the control unit 117 may return to operation 250. If the matching ratio is not higher than the threshold value, the control unit 117 may calibrate the user map or the base map, or the control unit 117 may display a tip or a message for the user to assist editing of the user map.

Further, the control unit 117 may transmit the synthesized map obtained in operation 270 to the server 120 via the communication unit 114, and may transmit a request message for a map update to the server 120, thereby allowing the corresponding synthesized map to be shared with other users. The control unit 117 may transmit user tagging information (such as memos, photos, or audio files) to the server 120 along with the synthesized map obtained in operation 270 so that the server 120 may classify and store the corresponding synthesized map in the server 120 with reference to the user tagging information. In an example, the server 120 may display various synthesized user maps for a specific area along with the tagging information. Thus, anonymous users who access the server 120 may choose a synthesized user map with reference to the tagging information. The control unit 117 may also transmit GPS information, scale information, direction information, information of the acquired base map, application version information, and editor information, etc to the server 120 along with the synthesized map obtained in operation 270.

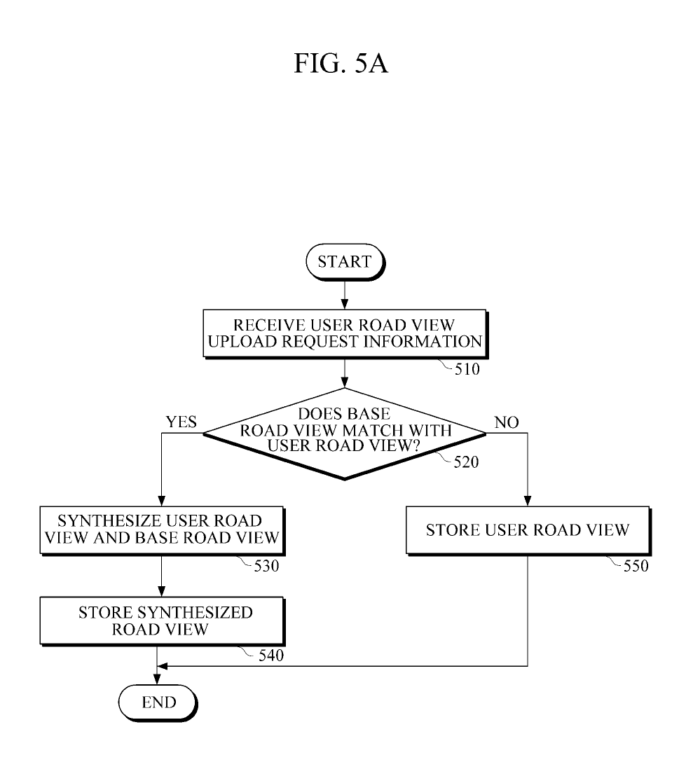

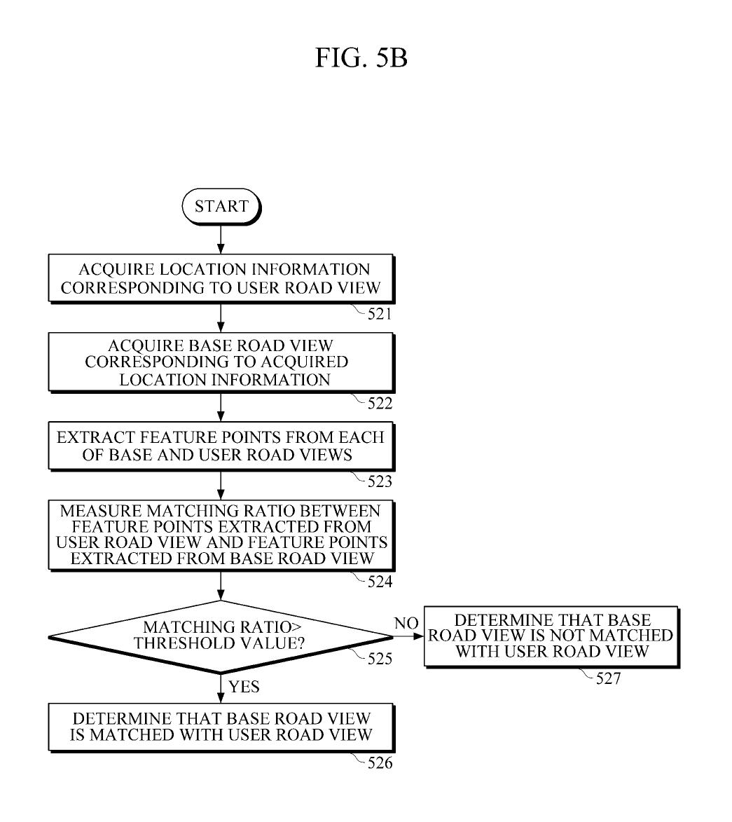

FIG. 5A and FIG. 5B are flowcharts illustrating a method for providing location-based data according to an exemplary embodiment of the invention. For ease of description, FIG. 5A and FIG. 5B will be described as if the method is performed by the server 120. However, the method is not limited as such.

Referring to FIG. 5A, the control unit 123 of the server 120 receives user road view data upload request information from the terminal 110 (510). The user road view data upload request information may include a user road view captured by the terminal 110 and location information, terrestrial magnetic information, and acceleration (3-axis direction) information of the terminal 110. If the location information is not sufficiently accurate due to she inaccuracy of GPS information, the user of the terminal 110 may select its location from a map, and may correct its location information. The user road view data upload request information may also include the date and time of the capturing of the user road view and lighting information corresponding to the lighting conditions at the time of the capturing of the user road view in order to facilitate the comparison of the user road view with a base road view.

The control unit 123 determines whether there is a base road view that matches with the user road view (520). If it is determined that there is a base road view that matches with the user road view, the control unit 123 synthesizes the user road view with the base road view that matches with the user road view (530). Next, the synthesized road view is stored in the server 120 (540). If it is determined that there is no base road view that matches with the user road view, the control unit 123 may store the user road view along with relevant information (550).

Hereinafter, operation 520 will be described in further detail with reference to FIG. 5B.

Referring to FIG. 5B, the control unit 123 acquires location information corresponding to a user road view from the road view data update request information (521). The control unit 123 acquires a base road view corresponding to the acquired location information from the base DB 122a (522). The control unit 123 extracts feature points from the user road view and the base road view (523). The control unit 123 measures the matching ratio between the feature points extracted from the user road view and the feature points extracted from the base road view (524). The control unit 123 determines whether the matching ratio is higher than a threshold value (525).

If the matching ratio is higher than the threshold value, the control unit 123 determines that the base road view is matched with the user road view (526). On the other hand, if the matching ratio is not higher than the threshold value, the control unit 123 determines that the base road view is not matched with the user road view (527).

Common features such as feature points of road views and boundaries of maps are used to identify corresponding region of a base location-based data in comparison with a user location-based data. After identifying the corresponding region of the base location-based data the user location-based data may be synthesized into the corresponding region of the base location-based data.

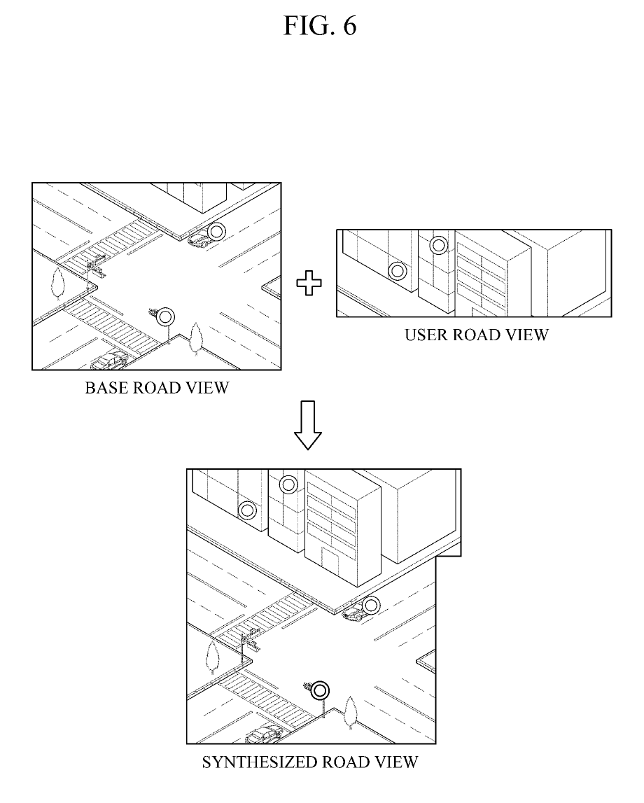

FIG. 6 is a diagram illustrating synthesizing of a user road view and a base road view according to an exemplary embodiment of the invention.

The control unit 123 stores the synthesized road view obtained in operation 530 in the user DB 122b in operation 540, as illustrated in FIG. 5A. If it is determined that there is no base road view that matches with the user road view, the control unit 123 stores the user road view in the user DB 122b in operation 550. For example, the synthesized road view obtained in operation 530 may be stored in the user DB 122b along with relevant information obtained by the terminal 110, including GPS information, terrestrial magnetic information, and acceleration information, so as to be properly reused by and shared between the terminal 110 and other terminals. Further, the synthesized road view may be stored along with additional information such as product information of the corresponding base road view. If the relevant information such as GPS information, terrestrial magnetic information, and acceleration information or the additional information is received, the control unit 123 may extract a synthesized road view based on the received information and may transmit the extracted synthesized road view to the terminal 110.

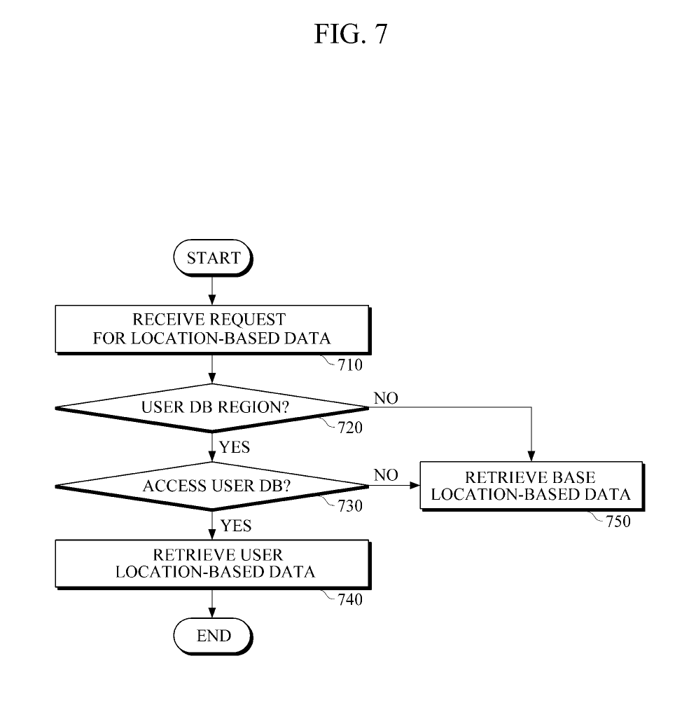

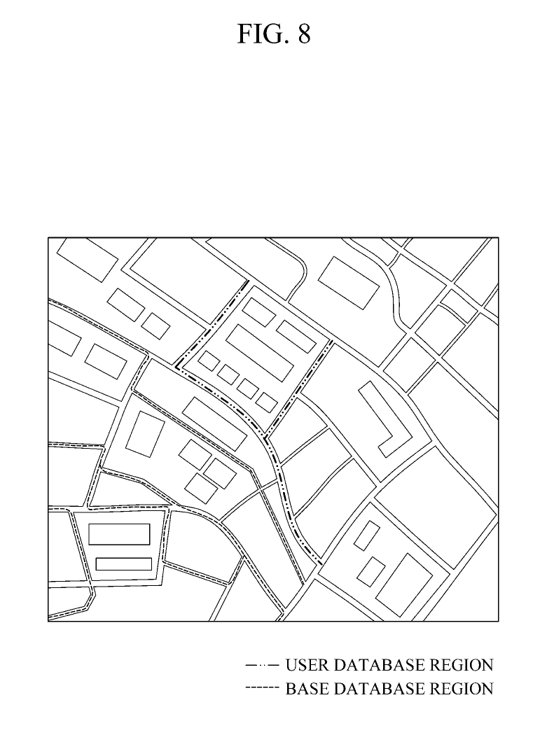

FIG. 7 is a diagram illustrating a provision of a road view to a terminal according to an exemplary embodiment of the invention, and FIG. 8 is a diagram illustrating a map showing regions where user road views are available and regions where base road views are available according to an exemplary embodiment of the invention.

As shown in FIG. 8, regions where user location-based data including user road view data is available (“user database region”) and regions where base location-based data including base road view data is available (“base database region”) are indicated by different indicators (e.g., dash with two dots for user database region, and short dash line for base database region, as shown in FIG. 8). The user location-based data stored in the user database (DB) may include user maps or user road views.

Referring to FIG. 7, the server 120 receives a request for location-based data from the terminal 110 along with the location information of the terminal 110 (710). The request for location-based data includes location information of a target location. Next, the control unit 123 of the server 120 determines whether the location information belongs to a user database region (720). If it is determined that the location information belongs to the user database region, the control unit 123 determines whether a request message for accessing a user DB is received from the terminal 110 (730).

If it is determined that the terminal 110 requested to access the user DB, the control unit 123 retrieves user location-based data stored in the user DB (740). For example, the control unit 123 may retrieve synthesized data obtained by synthesizing user location-based data and base location-based data.

If it is determined that the location information does not belong to the user database region or it is determined that the terminal 110 has not requested access to the user DB, she control unit 123 retrieves base location-based data stored in a base DB. (750).

Alternatively, the control unit 123 of the server 120 determines whether the terminal 110 is located in a user database region (720′).

If it is determined that the terminal 110 is located in the user database region, the control unit 123 determines whether a request message for accessing a user DB is received from the terminal 110 (730′). For example, referring to FIG. 8, the control unit 123 may determine whether a terminal in a user DB region requested the provision of user location-based data.

If it is determined that the terminal 110 requested to access the user DB, the control unit 123 retrieves user location-based data stored in the user DB (740′). For example, the control unit 123 may retrieve synthesized data obtained by synthesizing user location-based data and base location-based data.

If it is determined that the terminal 110 is not located in the user database region or it is determined that the terminal 110 has not requested access to the user DB, the control unit 123 retrieves base location-based data stored in a base DB. (750′).

As described above, it is possible to expand digital map data and thus to address the problem of the limits of existing digital map data. Further, it is possible to provide detailed location-based data that cannot be acquired from base map data provided by service providers by using user map data provided by users.

In addition, it is possible to provide additional, detailed road view data that cannot be acquired from base road view data provided by service providers by using user road view data provided by the user.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing location-based data, the method comprising:
acquiring user location-based data including location information;
acquiring base location-based data; and
synthesizing the user location-based data into a corresponding region of the base location-based data.

2. The method of claim 1, wherein the user location-based data comprises a user map or a user road view, and the base location-based data comprises a base map or a base road view.

3. The method of claim 1, further comprising:
identifying the corresponding region of the base location-based data based on the location information of the user location-based data and the location information of the base location-based data.

4. The method of claim 2, wherein synthesizing further comprises:
extracting boundaries of the user map and boundaries of the base map;
editing the user map or the base map so that the extracted boundaries of the user map matches with the extracted boundaries of the base map; and
generating a synthesized map.

5. The method of claim 2, further comprising:
providing a guideline comprising an overlap of boundaries of the user map and boundaries of the base map.

6. The method of claim 4, further comprising:
marking a location of a user on the synthesized map based on the location information of the user.

7. The method of claim 4, further comprising:
transmitting a request for displaying the synthesized map.

8. The method of claim 2, wherein the user location-based data comprises information corresponding to an acquired location of the user road view, terrestrial magnetic information, and acceleration information.

9. The method of claim 8, wherein synthesizing step further comprises:
determining whether there is a base road view that matches with the user road view; and
synthesizing the user road view and the base road view that matches with the user road view.

10. The method of claim 9, wherein the determining further comprises:
acquiring the base road view corresponding to the user road view based on the location information of the user road view;
extracting feature points from the user road view and feature points from the base road view;
measuring a matching ratio between the feature points of the user road view and the feature points of the base road view; and
determining that the base road view matches with the user road view if the matching ratio is higher than a threshold value.

11. A method for providing location-based data, the method comprising:
receiving a request for location-based data including location information;
determining whether the location information belongs to a user database region for which user location-based data is available;
extracting synthesized data including the user location-based data and a base location-based data if the location information belongs to the user database region; and
providing the synthesized data.

12. The method of claim 11, further comprising determining whether the request includes an access request to a user database,
wherein the synthesized data is extracted from the user database if the request includes the access request to the user database.

13. The method of claim 11, wherein the user location-based data comprises a user map or a user road view.

14. An apparatus to provide location-based data, comprising:
a communication unit to transmit data to a server and to receive base location-based data from the server via a communication network;
a display unit to display the base location-based data; and
a control unit to control the display unit to display synthesized data including first user location-based data and the base location-based data.

15. The apparatus of claim 14, further comprises an image acquisition unit to acquire second user location-based data,
wherein the control unit acquires a corresponding region of base location-based data based on location information of the second user location-based data, and synthesizes the second user location-based data into the corresponding region of the base location-based data.

16. The apparatus of claim 15, further comprising:
a manipulation unit to receive a request for displaying synthesized data;
a sensor unit to sense at least one of a current location of the apparatus, image capturing direction of the image acquisition unit, moving speed of the apparatus, acceleration of the apparatus, azimuth angle, inclination angle of the apparatus, and GPS information; and
a memory unit to store the second user location-based data.

17. The apparatus of claim 14, wherein the user location-based data comprises a user map or a user road view.

18. A server apparatus to provide location-based data, comprising:
a communication unit to transmit and receive data to and from a terminal via a communication network;
a base database to store base location-based data provided by a service provider;
a control unit to synthesize a user location-based data and the base location-based data into synthesized data; and
a database to store the synthesized data.

19. The server apparatus of claim 18, wherein the control unit extracts common features of the user location-based data and the base location-based data, and identifies a corresponding region of the base location-based data.

20. The server apparatus of claim 18, wherein the user location-based data comprises a user map or a user road view.
